(19) United States
(12) Patent Application Publication
(10) Pub. No.: US 2014/0346207 A1
(43) Pub. Date: Nov. 27, 2014

(54) STROLLER STREAMER SPONGE CARRIER, hypoallergenic carrier, holder for mobile streaming devices such as iPod, iPad, iPhone,iPad Mini, Kindle, Nook, and all or any mobile device able to stream Internet, video, and ,apps. Stroller Streamer Sponge Carrier may also be used when stationary

(71) Applicant: Shawna Mccallister, Anaheim, CA (US)

(72) Inventor: Shawna Mccallister, Anaheim, CA (US)

(21) Appl. No.: 13/902,833

(22) Filed: May 26, 2013

(51) Int. Cl. B62B 9/26

(52) U.S. Cl. CPC B62B 9/26
USPC 224/409

(57) ABSTRACT

A hypoallergenic sponge method of carrying a mobile internet streaming device such as IPOD, IPAD, IPHONE, IPAD MINI, KINDLE, NOOKS, and all or any mobile device for the purpose of providing entertainment for babies/children, adolescents, while riding in a stroller or any other mobile chair, car, wagon, wheelchair. A method of providing a safe place to store desired mobile device safely while traveling and may also be conveniently removed from stroller for car, stationary use or other areas of use. The Stroller Streamer Sponge Carrier/Holder is helpful for parents/or guardian's when out and about to provide much needed entertainment to infants and children when adults are shopping, doing laundry or interacting for example. The sponge stroller streamer device carrier/holder has three fitted pouch pockets which may be attached to the middle of the sponge stroller streamer device carrier/holder via Velcro which is reinforced with a magnet.

### FIELD OF THE INVENTION

STROLLER STREAMER SPONGE CARRIER—carrier-holder for devices such as IPOD, IPAD, IPHONE, IPAD MINI, KINDLE, NOOKS, and all or any mobile device able to stream internet, apps and Wi-Fi for desired features displayed on screen of device.

Stroller Streamer Sponge Carrier—Hypoallergenic Stroller Streamer Sponge carrier/holder for devices such as IPOD, IPAD, IPHONE, IPAD MINI, KINDLE, NOOKS, PHONES and all or any mobile device that is able to stream Apps, YouTube, Netflix, or any other desired feature displayed on screen of device used for entertainment of all kinds. Sponge Stroller Streamer Carrier-Holder is a carrying sponge/foam material method that straps conveniently to a stroller (may be attached to other mobile chairs/carts as well) and is easy to remove for on the go purposes. Stroller Streamer Sponge Carrier may be used while parents are on the go with their children in the stroller. The Sponge Stroller Streamer Carrier has a top handle for carrying when not attached to stroller or other areas. The sponge stroller streamer device carrier/holder has three fitted pouch pockets that can be attached to the middle of the sponge stroller streamer device carrier/holder via Velcro which is reinforced with a magnet. The fitted pouch pockets have a clear plastic front cover for easy access of the touch screen of the mobile devices for access to internet and app streaming while the back of the pocket pouches have Velcro. A small piece of tin may be imbedded under the Velcro for magnetic attachment. The Stroller Streamer Carrier provides a safe place to attach your IPOD, IPAD, IPHONE, IPAD MINI, KINDLE, NOOKS, and all or any mobile device while you push the stroller so that the child may enjoy the streaming of his/her favorite shows while also protecting the device. This also provides for a distraction for the child so that parents/guardians may be able to shop or do laundry or any other task while baby/children are also entertained.

The present invention relates to a method for controlling motion mobile devices while walking, pushing a stroller, driving, mobile devices in attached or fit into a pocket which then is attached to the main Stroller Streamer Carrier/Holder via Velcro and magnet.

### BACKGROUND

On the back of the Stroller Streamer Sponge Carrier-Holder there are two straps that conveniently connect the device carrier to the stroller. There are also two triangular areas imbedded into the material on the back of the Stroller Streamer Carrier to keep the device carrier in place when traveling. There are also two bottom clips which are able to become separated from the bottom end of the device carrier to be able to set the device carrier up-right when stationary. Within the backing of the Stroller Streamer Carrier there is a plastic backing with contains a circular shaped rare earth magnet which is imbedded into the plastic for safety reasons.

### SUMMARY OF THE INVENTION

### Stroller Streamer Sponge Carrier-Holder

Stroller Streamer Sponge Carrier—Hypoallergenic Stroller Streamer Sponge carrier/holder for devices such as IPOD, IPAD, IPHONE, IPAD MINI, KINDLE, NOOKS, PHONES and all or any mobile device that is able to stream Apps, YouTube, Netflix, or any other desired feature displayed on screen of device used for entertainment of all kinds. Useful Sponge Stroller Streamer Carrier-Holder is a carrying sponge/foam material method that straps conveniently to a stroller (may be attached to other mobile chairs/car as well) and is easy to remove for on the go purposes. Stroller Streamer Sponge Carrier may be used while parents are on the go with their children in the stroller. The Sponge Stroller Streamer Carrier has a top handle for carrying when not attached to stroller or other areas. The sponge stroller streamer device carrier/holder has three fitted pouch pockets that can be attached to the middle of the sponge stroller streamer device carrier/holder via Velcro which is reinforced with a magnet. The fitted pouch pockets have a clear plastic front cover for easy access of the touch screen of the mobile devices for access to internet and app streaming while the back of the pocket pouches have Velcro. The Stroller Streamer Carrier provides a safe place to attach your IPOD, IPAD, IPHONE, IPAD MINI, KINDLE, NOOKS, and all or any mobile device while you push the stroller so that the child may enjoy the streaming of his/her favorite shows while also protecting the device. This also provides for a distraction for the child so that parents/guardians may be able to shop or do laundry or any other task while baby/children are also entertained.

### BRIEF DESCRIPTION INVENTION AND DRAWINGS

Stroller Streamer Sponge Carrier—Hypoallergenic Stroller Streamer Sponge carrier/holder for devices such as IPOD, IPAD, IPHONE, IPAD MINI, KINDLE, NOOKS, PHONES and all or any mobile device that is able to stream Apps, YouTube, Netflix, or any other desired feature displayed on screen of device used for entertainment of all kinds. Useful Sponge Stroller Streamer Carrier-Holder is a carrying sponge/foam material method that straps conveniently to a stroller (may be attached to other mobile chairs/car as well) and is easy to remove for on the go purposes. Stroller Streamer Sponge Carrier may be used while parents are on the go with their children in the stroller. The Sponge Stroller Streamer Carrier has a top handle for carrying when not attached to stroller or other areas. The sponge stroller streamer device carrier/holder has three fitted pouch pockets that can be attached to the middle of the sponge stroller streamer device carrier/holder via Velcro which is reinforced with a magnet. The fitted pouch pockets have a clear plastic front cover for easy access of the touch screen of the mobile devices for access to internet and app streaming while the back of the pocket pouches have Velcro. The Stroller Streamer Carrier provides a safe place to attach your IPOD, IPAD, IPHONE, IPAD MINI, KINDLE, NOOKS, and all or any mobile device while you push the stroller so that the child may enjoy the streaming of his/her favorite shows while also protecting the device. This also provides for a distraction for the child so that parents/guardians may be able to shop or do laundry or any other task while baby/children are also entertained.

Having thus described the invention in general terms, reference will now be made to the accompanying drawings, which are not necessarily drawn to scale, and wherein:

FIG. 1. Shows schematically a block diagram of the Stroller Streamer Sponge Carrier Hypoallergenic Sponge (and/or foam) material overall dimensions Height: 9 in Width: 11.125 in×2.0 in This part of the Stroller Streamer Sponge Carrier will be covered in water resistant material that can be wiped down if gets dirty.

FIG. 2. Stroller Streamer Sponge Carrier Strap Handle for Carrying and stationary use also made out of Velcro and may be adjusted.

FIG. 3. shows schematically a diagram Stroller Streamer Sponge Carrier (Hypoallergenic Sponge) Height: 9.625 in×Width: 7.50 in×0.37 in

FIG. 4. Illustrate the Approximate Dimensions ⅞″ dia.× 3/32″ thick diameter magnet in center of plastic imbedded into the plastic backing.

FIG. 5. Illustrate the Velcro backing for fitted pocket pouch which fits in the middle area as described in FIG. 2. Height: 9.625 in×Width 7.50 in×0.37 in. A small piece of tin may be imbedded under the velcro for magnetic attachment.

FIG. 6. Illustrate the large size Velcro Pocket Pouch backing for fitted pocket pouch with clear plastic on the front of pouch. Height: 9.625 in×Width 7.50 in×0.37. Fitted Pocket Pouch has clear plastic center for viewing purposes.

FIG. 7. Illustrate the medium size of area for mobile device. Velcro Pocket Pouch Height: 7.87 in×Width 5.3 in×0.28 in which is also secured by the center magnet inside of the plastic backing. Fitted Pocket Pouch has clear plastic center for viewing purposes.

FIG. 8. Illustrate the small size of area for mobile device. Velcro Pocket Pouch Height: 4.54 in×Width 2.31 in×0.37 in and/or 5.33 in×2.67 in×0.35 in which is also secured by the center magnet inside of the plastic backing. This pocket pouch may be made to fit many types of mobile streaming phones or devices as the other pocket pouch may be made to fit several different mobile streaming devices which may be larger in size then a phone may be. Fitted Pocket Pouch has clear plastic center for viewing purposes.

FIG. 9. Illustrate the back of the Stroller Streamer Sponge Carrier/Holder (Hypoallergenic Sponge) Velcro adjustable straps, these straps are adjustable to fit and refit to a desired area which straps may be attached. These back straps are sown into the back of the material and plastic for better support for attachment.

FIG. 10. Illustrate the back of the Stroller Streamer Sponge Carrier/Holder (Hypoallergenic Sponge) Triangular Support Stabilizers are on the back of the stroller sponge carrier to help support the sponge from movement while traveling or mobile. These are also inside of the material of the sponge cover.

FIG. 11. Approximate Dimensions ⅞″ dia.× 3/32″ thick diameter magnet in center of plastic backing. FIG. 4. which is imbedded into the plastic backing. Please refer to FIG. 4.

FIG. 12. Retractable Stationary Support, 2 in×3.75 in×2.5 in, this is also imbedded with a light type of magnetic material to keep the Retractable Stationary Support in place when not in use. This is made in this way for safety and convenience so that when mobile streaming device is attached to an object such as a stroller the retractable stationary support will not be in the way, however, when needed can be pull away from the main Stroller Stream Sponge Carrier for stationary support use. Please refer to drawling for

[symbol]

All materials may or may not be used or changed in production for proper operations.

### DETAILED DESCRIPTION OF THE INVENTION AND DRAWINGS

Stroller Streamer Sponge Carrier—Hypoallergenic Stroller Streamer Sponge carrier/holder for devices such as IPOD, IPAD, IPHONE, IPAD MINI, KINDLE, NOOKS, PHONES and all or any mobile device that is able to stream Apps, YouTube, Netflix, or any other desired feature displayed on screen of device used for entertainment of all kinds. Useful Sponge Stroller Streamer Carrier-Holder is a carrying sponge method that straps conveniently to a stroller (may be attached to other mobile chairs/car as well) and is easy to remove for on the go purposes. Stroller Streamer Sponge Carrier may be used while parents are on the go with their children in the stroller. The Sponge Stroller Streamer Carrier has a top handle for carrying when not attached to stroller or other areas. The sponge stroller streamer device carrier/holder has three fitted pouch pockets that can be attached to the middle of the sponge stroller streamer device carrier/holder via Velcro which is reinforced with a magnet. The fitted pouch pockets have a clear plastic front cover for easy access of the touch screen of the mobile devices for access to internet and app streaming while the back of the pocket pouches have Velcro. The Stroller Streamer Carrier provides a safe place to attach your IPOD, IPAD, IPHONE, IPAD MINI, KINDLE, NOOKS, and all or any mobile device while you push the stroller so that the child may enjoy the streaming of his/her favorite shows while also protecting the device. This also provides for a distraction for the child so that parents/guardians may be able to shop or do laundry or any other task while baby/children are also entertained.

Hypoallergenic Sponge (and/or foam) overall dimensions, Height: 9 in×Width: 11.125 in×2.0 in

Velcro-used for a closure consisting of a piece of fabric of small hooks that sticks to a corresponding fabric of small piece.

Outer Material covering of Stroller Streamer Sponge Carrier that is washable—Note: not completely water proof however, may be wiped down to maintain cleanliness.

Fabric and cardboard material for pocket pouches

Rare Earth Magnets—stronger type of magnet material

### Detailed Description of the Invention and Drawings

The present inventions now will be described more fully hereinafter with reference to the accompanying drawings, in which some examples of the embodiments of the inventions are shown. Indeed, this invention may be embodied in many different forms and should not be construed as limited to the embodiments set forth herein; rather, these embodiments are provided by way of example so that this disclosure will satisfy applicable legal requirements. Like numbers refer to like elements throughout.

FIG. 1 Illustration schematically shows a block diagram of the Stroller Streamer Sponge Carrier Hypoallergenic Sponge (and/or foam) material, overall dimensions, Height: 9 in Width: 11.125 in×2.0 in. This is a soft outer sponge material that is hypoallergenic for the safety of child as well as adults with allergic reactions. This part of the Stroller Streamer Sponge Carrier as well as the whole covering of material will be covered in water proof-material that can be wiped down if needed and is also for convenience.

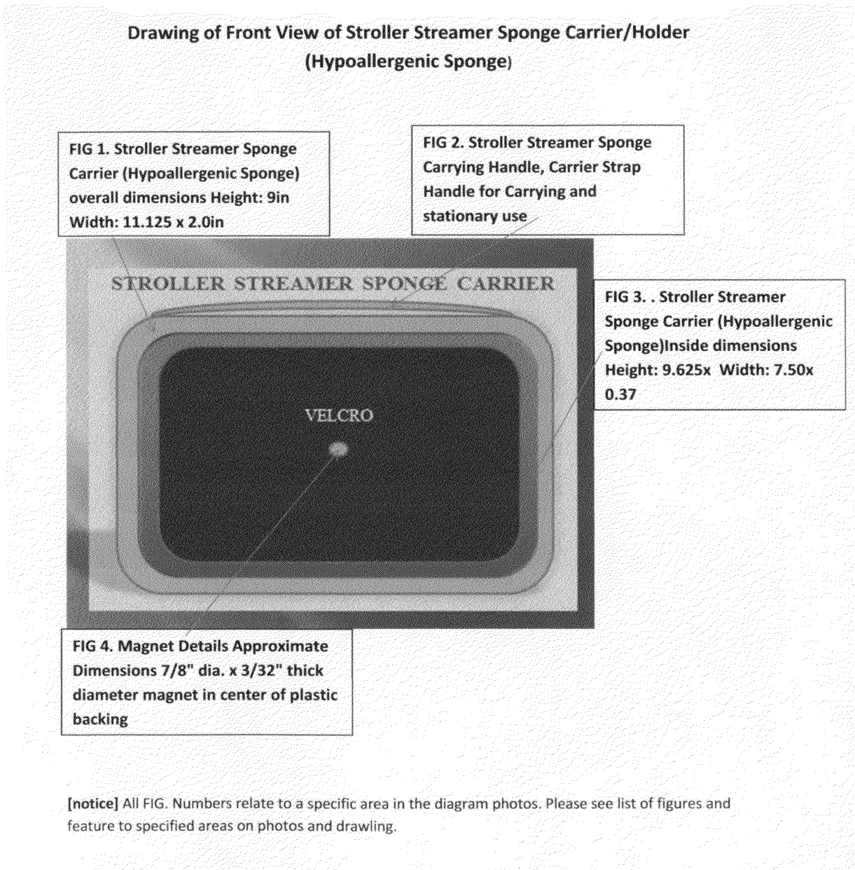

FIG. 2. Stroller Streamer Sponge Carrier Strap Handle for Carrying and stationary use also made out of Velcro and may be adjusted. Stroller Streamer Sponge Carrying Handle.

FIG. 3. Shows a diagram of inside dimensions of the Stroller Streamer Sponge Carrier (Hypoallergenic Sponge) Height: 9.625 in×Width: 7.50 in×0.37 in which fits inside of FIG. 1. Description area. This is made to fit mobile streaming devices within this size frame.

FIG. 4. Illustrate the magnet details and Approximate Dimensions ⅞″ dia.× 3/32″ thick diameter magnet in center of plastic imbedded into the plastic backing, this is also done for safety reasons avoiding accesses to small part by children. This magnet will also help to keep the mobile streaming device in place with assistance of the Velcro as well. A small piece of tin may be imbedded under the velcro for magnetic attachment.

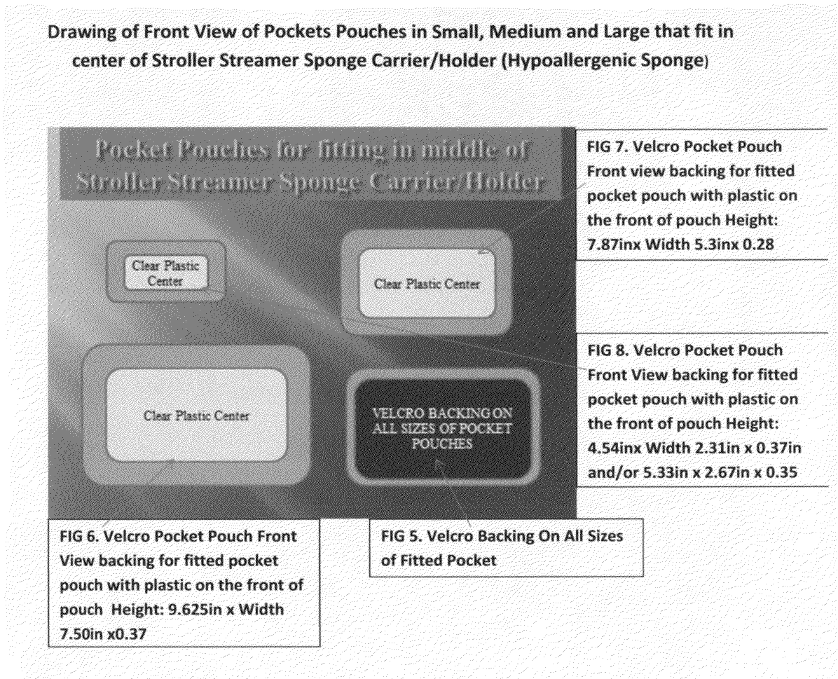

FIG. 5. Illustrate the Velcro backing for fitted pocket pouch which fits in the middle area as described in middle for all sizes of fitted Pocket Pouches. Height: 9.625 in×Width 7.50 in×0.37 in, Height: 7.87 in×Width 5.3 in×0.28, Height: 4.54 in×Width 2.31 in×0.37 in and/or 5.33 in×2.67 in×0.35. This area will have three different sizes for adjustable fits to a specific mobile streaming device. A small piece of tin may be imbedded under the velcro for magnetic attachment.

FIG. 6. Illustrate the front view of the large Velcro Pocket Pouch backing for fitted pocket pouch with plastic on the front of pouch Height: 9.625 in×Width 7.50 in×0.37. Fitted Pocket Pouch has clear plastic center for viewing purposes.

FIG. 7. Illustrate the front view of the medium size Velcro Pocket Pouch Height: 7.87 in×Width 5.3 in×0.28 in which is also secured by the center magnet inside of the plastic backing. Fitted Pocket Pouch has clear plastic center for viewing purposes.

FIG. 8. Illustrate the front view of the small size Velcro Pocket Pouch Height: 4.54 in×Width 2.31 in×0.37 in and/or 5.33 in×2.67 in×0.35 in which is also secured by the center magnet inside of the plastic backing. This pocket pouch may be made to fit many types of mobile streaming phones or devices as the other pocket pouch may be made to fit several different mobile streaming devices which may be larger in size then a phone may be. Fitted Pocket Pouch has clear plastic center for viewing purposes.

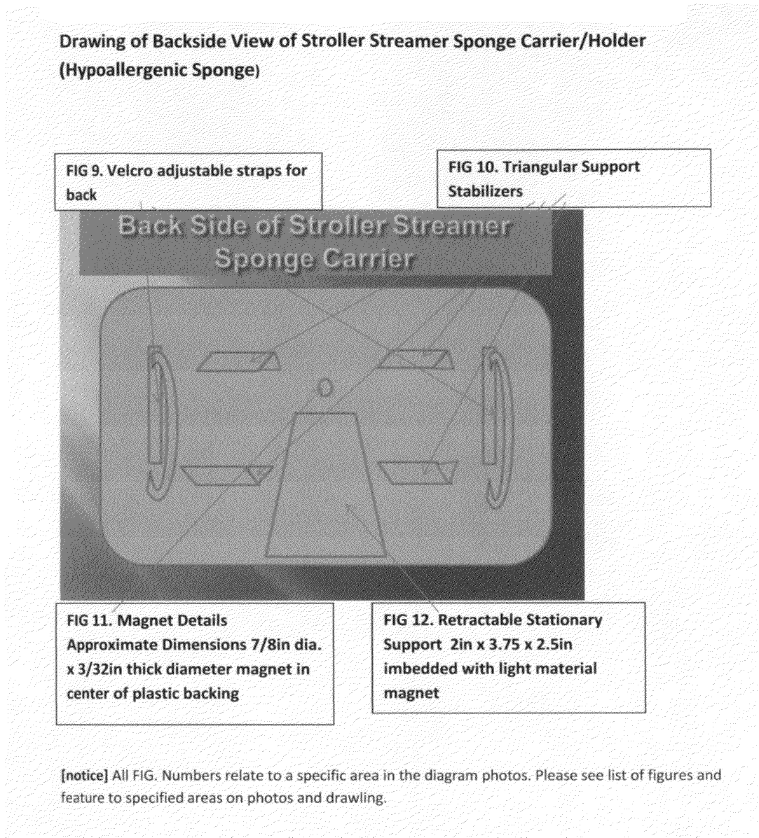

FIG. 9. Illustrate the back of the Stroller Streamer Sponge Carrier/Holder Velcro adjustable straps, these straps fit and refit when attached to desired area. These back straps are sown into the back of the material and plastic for better support for attachment. These areas may include but are not limited to stroller front area, stroller back area, and/or any other mobile riding or traveling transportations.

FIG. 10. Illustrate the back of the Stroller Streamer Sponge Carrier/Holder Triangular Support Stabilizers are on the back of the stroller sponge carrier to help support the sponge from movement while traveling or mobile. These are also inside of the material of the sponge cover.

FIG. 11. Magnet details, Approximate Dimensions ⅞″ dia.× 3/32″ thick diameter magnet in center of plastic backing. FIG. 4. which is imbedded into the plastic backing. Please refer to FIG. 4.

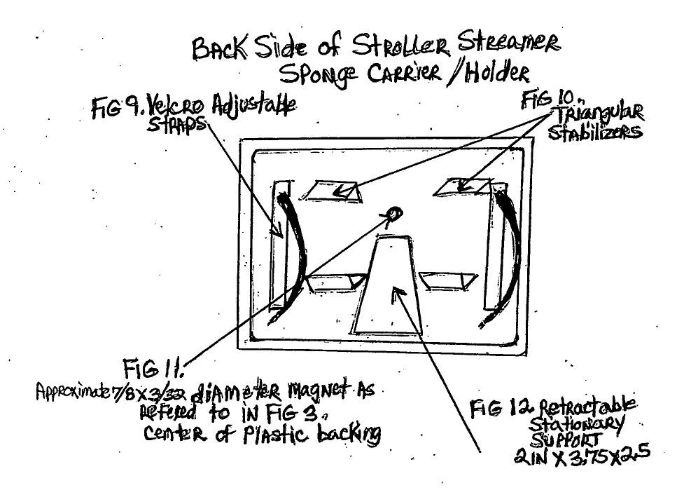

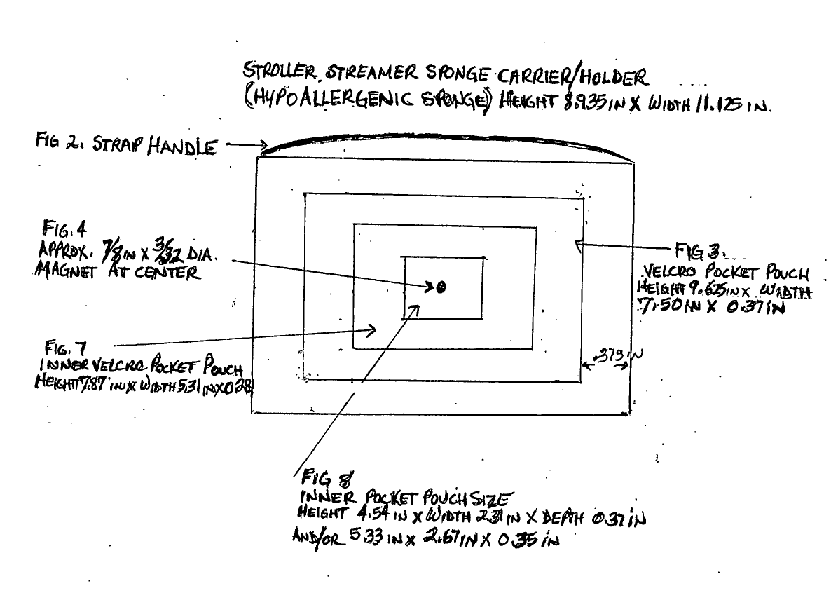

FIG. 12. Retractable Stationary Support, 2 in×3.75 in×2.5 in, this is also imbedded with a light type of magnetic material to keep the Retractable Stationary Support in place when not in use. This is made in this way for safety and convenience so that when mobile streaming device is attached to an object such as a stroller the retractable stationary support will not be in the way, however, when needed can be pull away from the main Stroller Stream Sponge Carrier for stationary support use. May or may not use magnetic materials.

All materials may or may not be used or changed in production for proper operations.

Please refer to drawling for more information.

1. A method of hypoallergenic sponge/foam material carrier/holder for a mobile internet streaming devices with a touch sensitive display, the method comprising the steps of: attaching the sponge stroller streamer device carrier/holder to the stroller or desired area for viewing your selected streaming device, attach proper fitted pouch pocket to the middle in the appropriate size area. The middle of the sponge stroller streamer device carrier/holder has a fitting area with three attachable sizes.

2. The method according to claim 1, three sizes of fitted pockets pouch areas included. The three fitted pouch pockets attach to the middle area of the Stroller Streamer Sponge carrier/holder via Velcro and magnetic force. Velcro areas and magnets keep the fitted pouch pocket in place and prevent the child from pulling the fitted pouch pockets from the main Sponge Stroller Streamer Carrier-Holder.

3. The method according to claim 1, the Stroller Streamer Sponge Carrier-Holder, can be attached to any desired stroller or area that back straps allow for properly. The Stroller Streamer Sponge Carrier-Holder is detachable from the stroller as are the middle fitted pouch pockets from the main Sponge Stroller Streamer Carrier-Holder. Stroller Streamer Sponge Carrier also has a handle on the top for totting when not attached or strapped to a stroller or other transportation device.

4. The method according to claim 1, the three fitted attachable pouch pockets are sized universally to allow for proper fit of the following devices, iPad, iPad Mini, iPod, iPhone, Nook, Kindle, Phones and all other mobile internet/app streaming devices.

5. The method according to claim 1, the fitted pockets pouches provide a clear plastic front cover to allow the user to touch front operating screen on the mobile devices. This allows for the changing of apps and desired streaming from the internet devices.

6. The method according to claim 1, each fitted pouch pocket has Velcro attached to the back of it and is formed fitted to fit inside the main Stroller Streamer Sponge carrier/holder. There is also a plastic backing to the Sponge Stroller Streamer Carrier which contains an earth magnet which offers additional support to the attachment of the mobile devices to the Stroller Streamer Sponge carrier/holder

7. The method according to claim 1, all attachments have been attached for the safety of children and there are no small parts that are choke-able, however, parents and/or guardians must be present at all time while Stroller Streamer Sponge Carrier in use for children under 7 years of age for safety of children and safety of all devices used or attached to Stroller Streamer Sponge Carrier. The Hypoallergenic Stroller Streamer Sponge carrier/holder has been designed for child safety as the main objective.

8. The method according to claim number 1., and number 2., the back of the Hypoallergenic Stroller Streamer Sponge carrier/holder has two straps which also contain Velcro for desired adjustment purposes. The backing of the Hypoallergenic Stroller Streamer Sponge carrier/holder also contains a plastic backing that is attached to the inside of the sponge area for support of the Hypoallergenic Stroller Streamer Sponge carrier/holder. This plastic area also provides for a “kick-stand” which is also used by pulling the stand out away from the magnet to make the Hypoallergenic Stroller Streamer Sponge carrier/holder able to stand on a hard surface which may be used for stationary use.

9. Warning: Research has shown that while the magnets do not seem to pose any threat to any mobile streaming devices that do not obtain hard-dives or floppy disk materials. Studies do show that while mobile devices are attached to a magnetic force there may cause interruption with navigation or GPS features. Research shows flash memory utilizes solid state chips are not affected by magnets.
